(19) United States
(12) Patent Application Publication
(10) Pub. No.: US 2025/0323425 A1
(43) Pub. Date: Oct. 16, 2025

(54) COMMUNICATION DEVICE AND DRIVING METHOD THEREOF

(71) Applicant: Innolux Corporation, Miaoli County (TW)

(72) Inventors: Yi-Hung Lin, Miaoli County (TW); Kung-Chen Kuo, Miaoli County (TW); Kazuyuki Hashimoto, Miaoli County (TW)

(73) Assignee: Innolux Corporation, Miaoli County (TW)

(21) Appl. No.: 19/083,462

(22) Filed: Mar. 19, 2025

Related U.S. Application Data
(60) Provisional application No. 63/633,060, filed on Apr. 12, 2024.

(30) Foreign Application Priority Data
Dec. 25, 2024 (CN) 202411928804.8

(51) Int. Cl. H01Q 21/06

(52) U.S. Cl. CPC H01Q 21/061

(57) ABSTRACT

A communication device and a driving method thereof are provided. The communication device includes a substrate, a plurality of scan lines, and a plurality of data lines. The plurality of scan lines are disposed on the substrate and divided into R scan line groups, where R is a positive integer greater than 1. A number of the plurality of data lines is R×S, S is a positive integer, and R scan lines are simultaneously turned on.

### CROSS-REFERENCE TO RELATED APPLICATION

This application claims the priority benefit of the U.S. provisional application Ser. No. 63/633,060, filed on Apr. 12, 2024 and the priority benefit of China application serial no. 202411928804.8, filed on Dec. 25, 2024. The entirety of each of the above-mentioned patent applications is hereby incorporated by reference herein and made a part of this specification.

### BACKGROUND

### Technical Field

The disclosure relates to a device, particularly to a communication device and a driving method thereof.

### Description of Related Art

For devices with a unit array, in order to achieve fast response functionality, how to implement rapid driving operations for multiple units in the unit array is currently a major problem to be solved in this field.

### SUMMARY

The disclosure is directed to a communication device and a driving method thereof. The communication device and driving method thereof of the disclosure may effectively shorten the driving time.

According to an embodiment of the disclosure, the communication device of the disclosure includes a substrate, a plurality of scan lines, and a plurality of data lines. The plurality of scan lines are disposed on the substrate and divided into R scan line groups, where R is a positive integer greater than 1. A number of the plurality of data lines is R×S, S is a positive integer, and R scan lines are simultaneously turned on.

According to an embodiment of the disclosure, the driving method of the disclosure is applicable to a communication device. The communication device includes a substrate, a plurality of data lines, and a plurality of scan lines. The plurality of data lines and the plurality of scan lines are disposed on the substrate. The plurality of scan lines are divided into R data line groups, where R is a positive integer greater than 1. A number of the plurality of data lines is R×S, and S is a positive integer. The driving method includes: providing a plurality of scan signals through the plurality of scan lines to a plurality of units in different rows, in which R scan lines are simultaneously turned on; and synchronously providing a plurality of data signals through the plurality of data lines to a plurality of units in each of a plurality of sub areas of the substrate.

Based on the above, the communication device and the driving method thereof of the disclosure may effectively shorten the duration of each frame period during the operation process of the communication device by synchronously driving a plurality of units in a plurality of sub areas of the unit array row by row.

To make the above content more easily understood, several embodiments accompanying the drawings will be described in detail below.

### BRIEF DESCRIPTION OF THE DRAWINGS

FIG. 1 is a schematic diagram of a communication device according to an embodiment of the disclosure.

FIG. 2 is a schematic diagram of a unit according to an embodiment of the disclosure.

FIG. 3 is a flowchart of a driving method according to an embodiment of the disclosure.

FIG. 4 is a waveform diagram of a plurality of signals according to an embodiment of the disclosure.

FIG. 5A to FIG. 5C are schematic diagrams of driving a unit array according to an embodiment of the disclosure.

FIG. 6 is a waveform diagram of a plurality of signals according to an embodiment of the disclosure.

FIG. 7 is a schematic diagram of a communication device according to an embodiment of the disclosure.

FIG. 8 is a schematic diagram of a communication device according to an embodiment of the disclosure.

### DESCRIPTION OF THE EMBODIMENTS

Reference will now be made in detail to the exemplary embodiments of the disclosure, and examples of the exemplary embodiments are illustrated in the accompanying drawings. Whenever possible, the same reference numerals are used in the drawings and the description to indicate the same or similar parts.

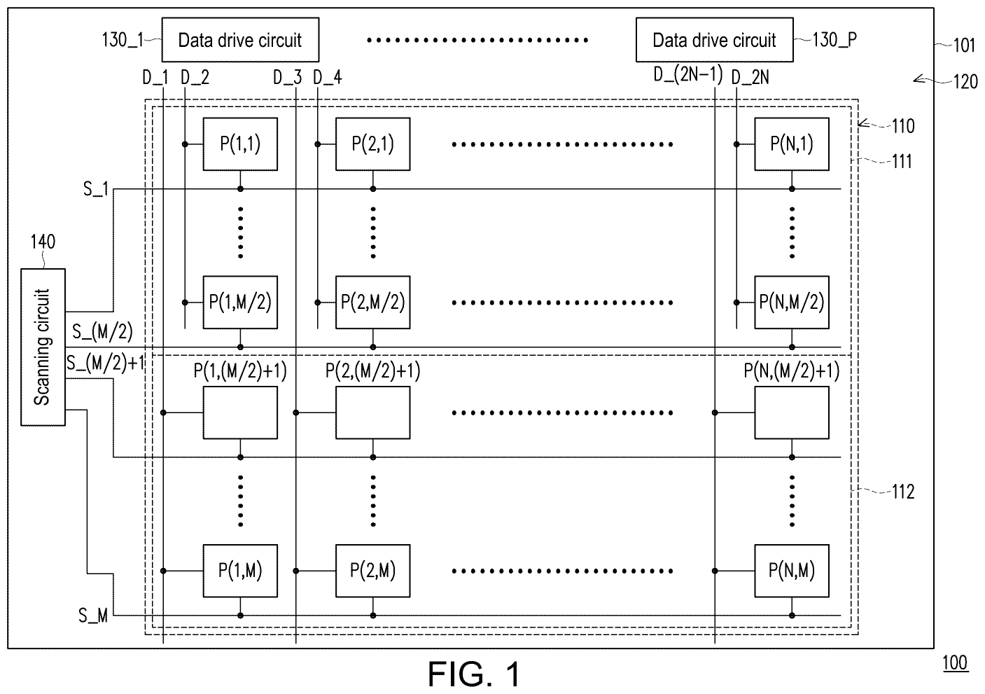

FIG. 1 is a schematic diagram of a communication device according to an embodiment of the disclosure. Referring to FIG. 1, it is first described that the communication device 100 of this embodiment includes a substrate 101, a unit array, a plurality of scan lines, and a plurality of data lines. The substrate 101 has a first area 110 and a second area 120. In this embodiment, the plurality of scan lines may be divided into R scan line groups, where R is a positive integer greater than 1. The number of the plurality of data lines is R×S, where S is a positive integer. In this embodiment, R scan lines are simultaneously turned on. In this embodiment, a plurality of units of the unit array may be divided into R unit groups, and the first area 110 may be divided into R sub areas. The R unit groups may be respectively disposed in the R sub areas, and the plurality of data lines are respectively coupled to the R unit groups. In this embodiment, the communication device 100 further includes a plurality of data drive circuits, respectively coupled to the plurality of data lines. The number of the plurality of data drive circuits may be R. The plurality of data drive circuits may synchronously drive a plurality of units in each of the R sub areas, and the plurality of units in each of the R sub areas are driven row by row.

As shown in FIG. 1, taking the number of sub areas as two as an example (the disclosure does not limit the number of sub areas), the communication device 100 includes a plurality of scan lines S_1 to S_M, a plurality of data lines D_1 to D_2N, a plurality of data drive circuits 130_1 to 130_P, and a scanning circuit 140, where M, N, and P are positive integers greater than 1. The number of data drive circuits 130_1 to 130_P may be equal to the number of sub areas, but the disclosure is not limited thereto. In this embodiment, the unit array is disposed in the first area 110 of the substrate 101 and has a plurality of units P(1,1) to P(N,M) in M rows and N columns. In this embodiment, the first area 110 may include sub areas 111 and 112. The unit array may include units P(1,1) to P(N,M), and the units P(1,1) to P(N,M) may be divided into two unit groups. The data lines D_1 to D_2N may include two data line groups (i.e., R=2), and the scan lines S_1 to S_M may also include two scan line groups (i.e., R=2). In this embodiment, the two unit groups may be respectively disposed in the two sub areas 111 and 112, and the two data line groups and two scan line groups may be respectively coupled to the two unit groups.

In this embodiment, the communication device 100 may be an antenna device, and the units P(1,1) to P(N,M) may be a plurality of antenna transceivers, but the disclosure is not limited thereto. The communication device 100 is manufactured using a low-temperature polycrystalline silicon (LTPS) process, and the substrate 101 may be a low-temperature polycrystalline silicon substrate. In this embodiment, the first area 110 may be an active area, and the second area 120 may be a peripheral area.

In this embodiment, the data lines D_1 to D_2N (i.e., R=2, S=N) are disposed in the first area 110 of the substrate 101, and are coupled to the units P(1,1) to P(N,M), where the number of data lines D_1 to D_2N is 2×N. The scan lines S_1 to S_M are disposed in the first area 110 of the substrate 101, and are coupled to the units P(1,1) to P(N,M). In this embodiment, the data drive circuits 130_1 to 130_P may be coupled to the units P(1,1) to P(N,M) through the data lines D_1 to D_2N, and provide a plurality of data signals to the units P(1,1) to P(N,M). In this embodiment, the scanning circuit 140 may be coupled to the units P(1,1) to P(N,M) through the scan lines S_1 to S_M, and provide a plurality of scan signals to the units P(1,1) to P(N,M).

Specifically, the units P(1,1) to P(N,M/2) may be the first unit group, and the units P(1,M/2) to P(N,M) may be the second unit group. The data drive circuit 130_1 may drive the units P(1,1) to P(N,M/2) of the first unit group disposed in the sub area 111 through the even-numbered data lines D_2 to D_2N, and the data drive circuit 130_2 may drive the units P(1,(M/2)+1) to P(N,M) of the second unit group disposed in the sub area 112 through the odd-numbered data lines D_1 to D_(2N−1). The scanning circuit 140 may drive the units P(1,1) to P(N,M/2) of the first unit group disposed in the sub area 111 through the scan lines S_1 to S_(M/2), and the scanning circuit 140 may drive the units P(1,(M/2)+1) to P(N,M) of the second unit group disposed in the sub area 112 through the scan lines S_(M/2)+1 to S_M.

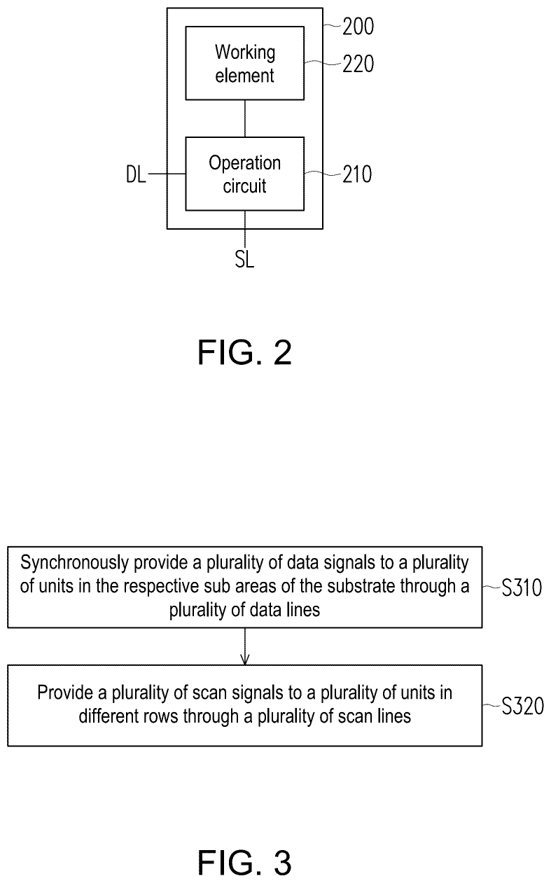

FIG. 2 is a schematic diagram of a unit according to an embodiment of the disclosure. Referring to FIG. 1 and FIG. 2, each of the units P(1,1) to P(N,M) in FIG. 1 may have the architecture of the unit 200 as shown in FIG. 2. In this embodiment, the unit 200 includes an operation circuit 210 and a working element 220. In this embodiment, the working element 220 may include a varactor or related antenna circuit elements. The operation circuit 210 may be coupled to the data line DL and the scan line SL to receive data signals and scan signals. When the operation circuit 210 simultaneously receives a scan signal and a data signal, the operation circuit 210 may drive the working element 220 according to the data signal and scan signal received. For this, the operation circuit 210 may, for example, charge the varactor in the working element 220 according to the data signal received.

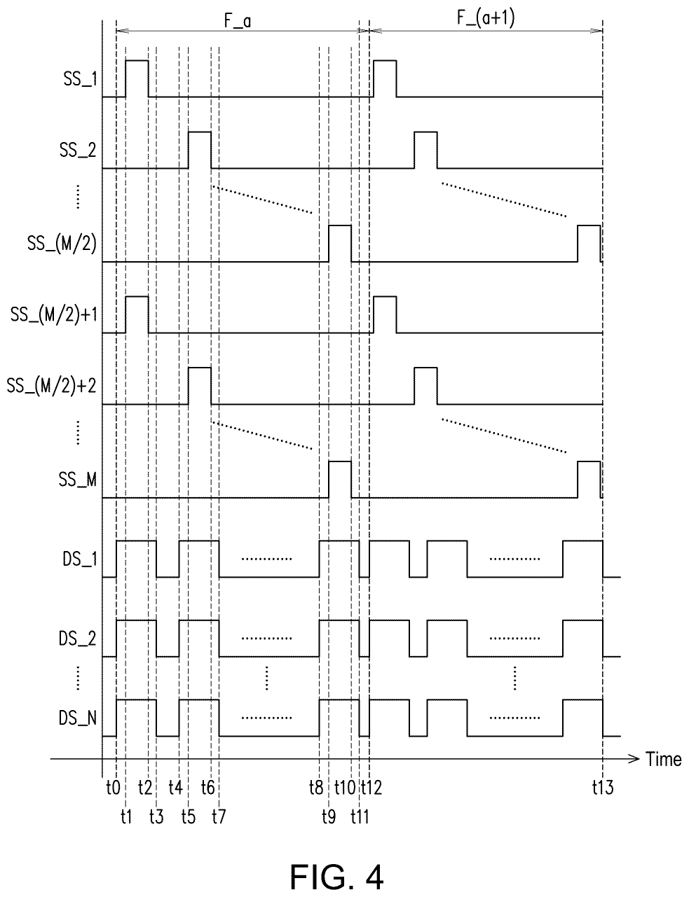

FIG. 3 is a flowchart of a driving method according to an embodiment of the disclosure. FIG. 4 is a waveform diagram of a plurality of signals according to an embodiment of the disclosure. Referring to FIG. 1, FIG. 3, and FIG. 4, the following description exemplifies a case where the number of sub areas is two. The communication device 100 may perform steps S310 to S320 as shown in FIG. 3. In step S310, the data drive circuits 130_1 to 130_P synchronously provide a plurality of data signals DS_1 to DS_2N to a plurality of units in the respective sub areas 111 and 112 of the substrate 101 through a plurality of data lines D_1 to D_2N. In this embodiment, the data drive circuits 130_1 to 130_P may be coupled to each other in a cascade manner for driving the units P(1,1) to P(N,M). In this embodiment, the data drive circuits 130_1 to 130_P may synchronously provide data signals DS_1 to DS_2N through the data lines D_1 to D_2N.

In step S320, the scanning circuit 140 may provide a plurality of scan signals SS_1 to SS_M to a plurality of units P(1,1) to P(N,M) in different rows through a plurality of scan lines S_1 to S_M. In this embodiment, the scanning circuit 140 may provide a plurality of scan signals SS_1 to SS_(M/2) to a plurality of units P(1,1) to P(N,M/2) in different rows through scan lines S_1 to S_(M/2). Simultaneously, the scanning circuit 140 may sequentially provide a plurality of scan signals SS_(M/2)+1 to SS_M to a plurality of units P(1,(M/2)+1) to P(N,M) in different rows through scan lines S_(M/2)+1 to S_M. Thus, the plurality of units in the respective sub areas 111 and 112 may be driven row by row.

Specifically, as shown in FIG. 4, during a frame period F_a from time t0 to time t12, the data drive circuits 130_1 to 130_P may synchronously provide data signals DS_1 to DS_2N with specific data to units P(1,1) to P(N,1) through data lines D_1 to D_2N (for example, at times t0, t4, t8), where a is a positive integer. Moreover, within this frame period F_a, the scanning circuit 140 may sequentially provide scan signals SS_1 to SS_(M/2) to units P(1,1) to P(N,M/2) in different rows (for example, at times t1, t5, t9), and synchronously and sequentially provide scan signals SS_(M/2)+1 to SS_M to units P(1,(M/2)+1) to P(N,M) in different rows (for example, at times t1, t5, t9). Furthermore, during the next frame period F_(a+1) from time t12 to time t13, the drive circuits 130_1 to 130_P and the scanning circuit 140 may implement the same driving method.

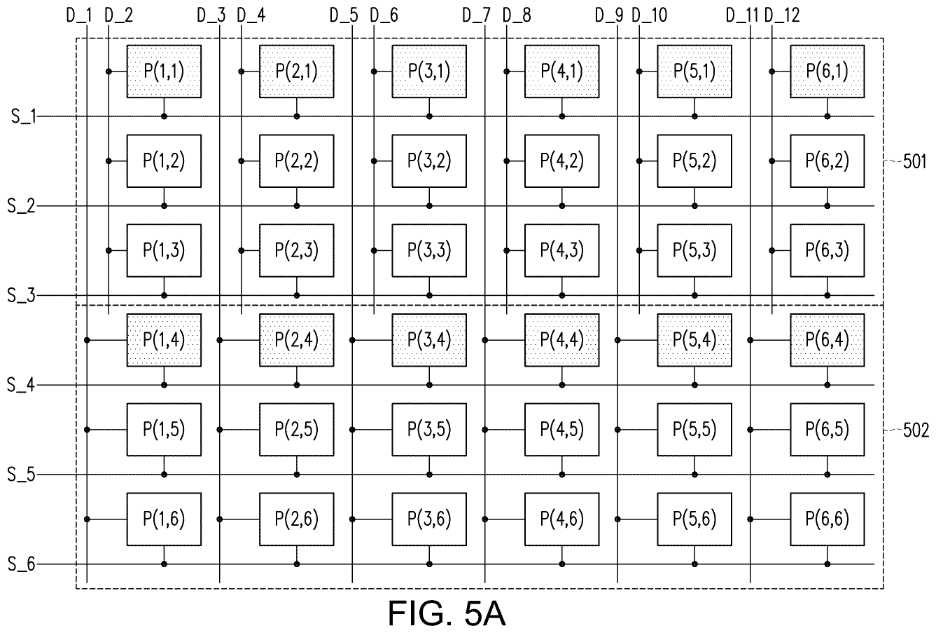

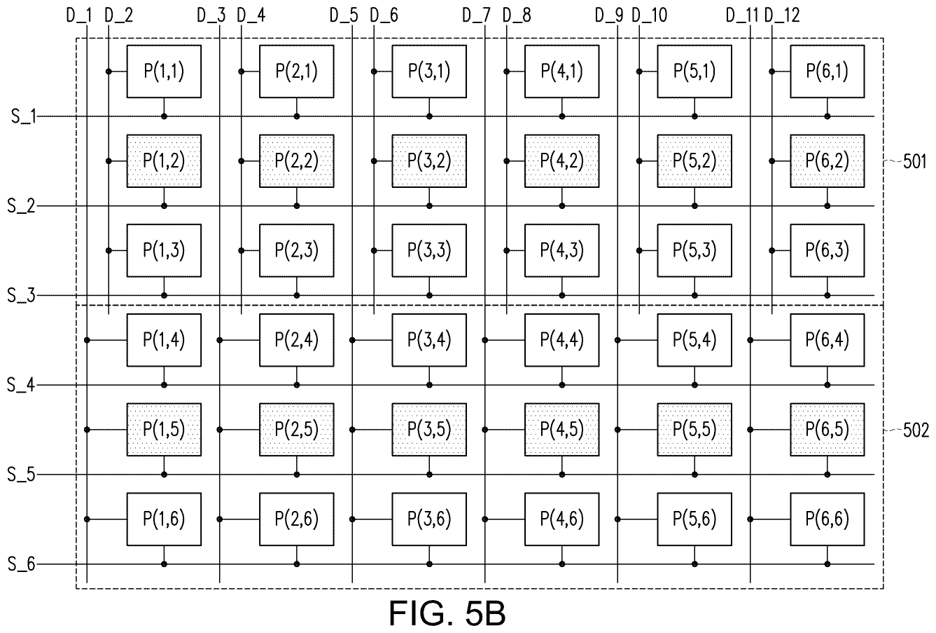

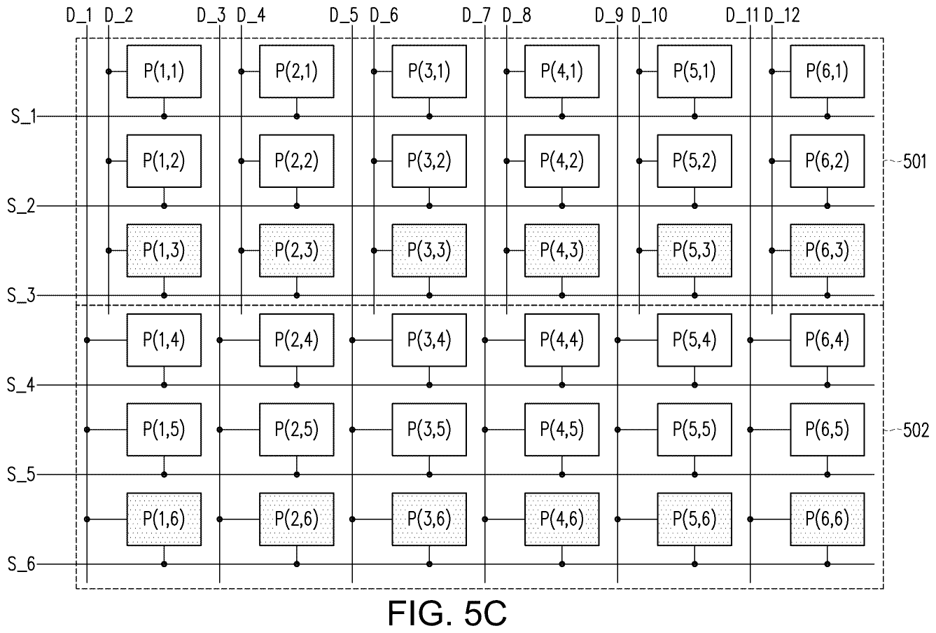

Thus, referring to FIG. 5A to FIG. 5C, FIG. 5A to FIG. 5C are schematic diagrams of driving a unit array according to an embodiment of the disclosure. As shown in FIG. 5A, taking units P(1,1) to P(6,6) as an example, at time t1 in FIG. 4, units P(1,1) to P(6,1) in sub area 501 and units P(1,4) to P(6,4) in sub area 502 may be driven simultaneously. Then, as shown in FIG. 5B, at time t5 in FIG. 4, units P(1,2) to P(6,2) in sub area 501 and units P(1,5) to P(6,5) in sub area 502 may be driven simultaneously. By analogy, as shown in FIG. 5C, at the next time point, units P(1,3) to P(6,3) in sub area 501 and units P(1,6) to P(6,6) in sub area 502 may be driven simultaneously. In other words, compared to the method of scanning all units P(1,1) to P(6,6) row by row, this embodiment may complete the driving operation of units P(1,1) to P(6,6) in one frame period with half the duration (i.e., saving half of the driving time) by using the method of synchronous row-by-row scanning by partitions.

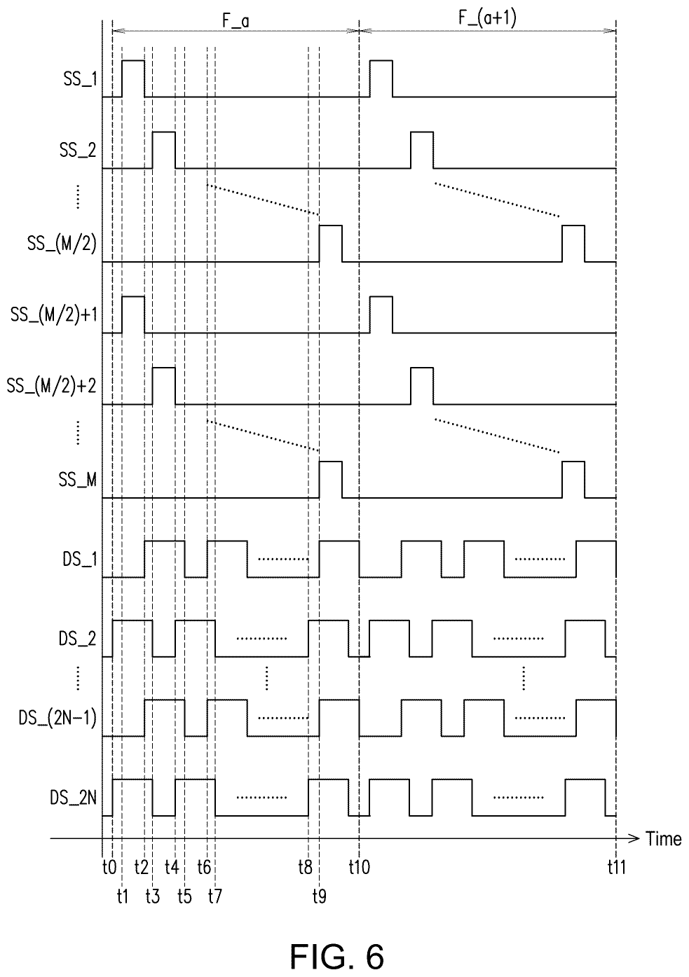

FIG. 6 is a waveform diagram of a plurality of signals according to an embodiment of the disclosure. Referring to FIG. 1 and FIG. 6, in one embodiment, the data drive circuits 130_1 to 130_P may also drive a plurality of units in different columns of a plurality of sub areas through an alternating driving method, in which the data drive circuits 130_1 to 130_P may alternately couple to a plurality of units in different columns. Taking two data drive circuits as an example, the data drive circuit 1301 may synchronously provide a plurality of data signals DS_2 to DS_2N to a plurality of units P(1,1) to P(N,M/2) in sub area 111 through even-numbered data lines D_2 to D_2N, and the data drive circuit 130_2 may synchronously provide a plurality of data signals DS_1 to DS_(2N−1) to a plurality of units P(1,(M/2)+1) to P(N,M) in sub area 112 through odd-numbered data lines D_1 to D_(2N−1).

Specifically, as shown in FIG. 6, during a frame period F_a from time t0 to time t10, the data drive circuit 130_1 may synchronously provide data signals DS_2 to DS_2N with specific data to units P(1,1) to P(N,M/2) through even-numbered data lines D_2 to D_2N (for example, at times t0, t4, t8), and the data drive circuit 1302 may synchronously provide data signals DS_1 to DS_(2N−1) with specific data to units P(1,(M/2)+1) to P(N,M) through odd-numbered data lines D_1 to D_(2N−1) (for example, at times t2, t6, t9). Moreover, during this frame period F_a, the scanning circuit 140 may sequentially provide scan signals SS_1 to SS_(M/2) to units P(1,1) to P(N,M/2) in different rows (for example, at times t1, t3, t9), and synchronously and sequentially provide scan signals SS_(M/2+1) to SS_M to units P(N,(M/2)+1) to P(N,M) in different rows (for example, at times t1, t5, t9). Furthermore, during the next frame period F_(a+1) from time t10 to time t11, the data drive circuits 130_1 to 130_P and the scanning circuit 140 may implement the same driving method.

Thus, as shown in FIG. 5A, taking units P(1,1) to P(6,6) as an example, at time t1 in FIG. 6, units P(1,1) to P(6,1) in sub area 501 and units P(1,4) to P(6,4) in sub area 502 may be driven simultaneously. Then, as shown in FIG. 5B, at time t3 in FIG. 6, units P(1,2) to P(6,2) in sub area 501 and units P(1,5) to P(6,5) in sub area 502 may be driven simultaneously. Similarly, as shown in FIG. 5C, at time t5 in FIG. 6, units P(1,3) to P(6,3) in sub area 501 and units P(1,6) to P(6,6) in sub area 502 may be driven simultaneously. In other words, compared to the method of scanning all units P(1,1) to P(6,6) row by row, this embodiment performs synchronous row-by-row scanning by partitions, and the waveforms of data signals for every two adjacent rows may partially overlap, which may save more than half of the driving time duration to complete the driving operation of units P(1,1) to P(6,6) in one frame period.

However, referring again to FIG. 1, in another embodiment, the data drive circuits 130_1 to 130_P may also drive a plurality of units in different columns of a plurality of sub areas through an alternating driving method, in which the data drive circuits 130_1 to 130_P may be coupled to a plurality of units in different consecutive columns. Taking two data drive circuits as an example, the data drive circuit 130_1 may synchronously provide a plurality of data signals DS_1 to DS_(N/2) to a plurality of units P(1,1) to P(N/2,M) in sub areas 111 and 112 through data lines D_1 to D_(N/2), and the data drive circuit 1302 may synchronously provide a plurality of data signals DS_(N/2)+1 to DS_2N to a plurality of units P((N/2)+1,1) to P(N,M) in sub areas 111 and 112 through data lines D_(N/2)+1 to D_2N. In this way, it may also save more than half of the driving time duration to complete the driving operation of units P(1,1) to P(N,M) in one frame period.

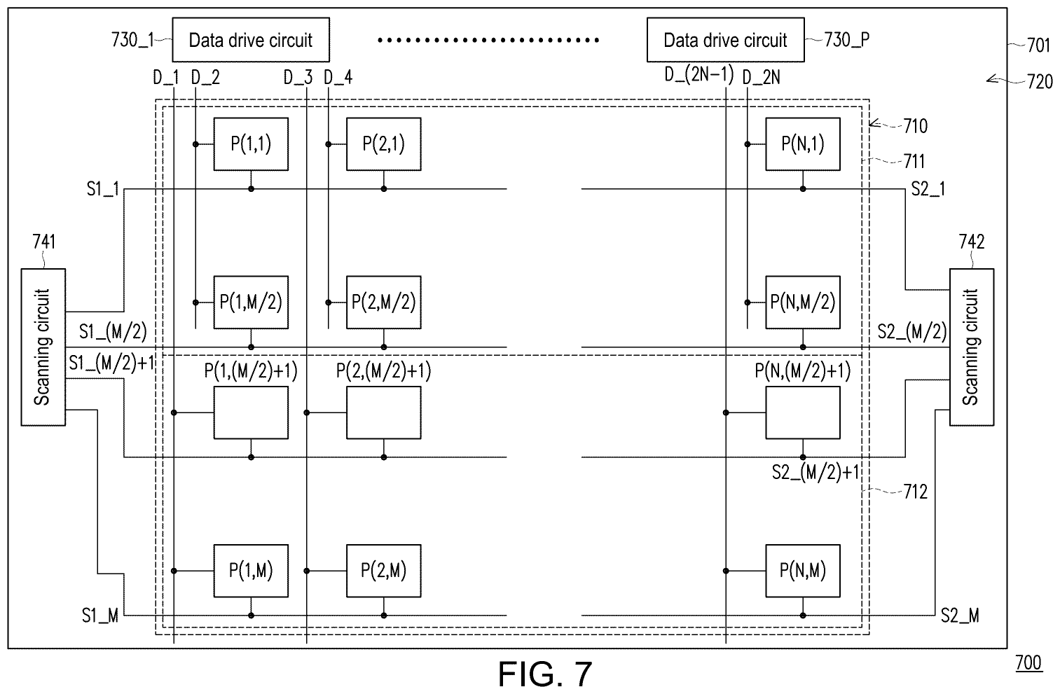

FIG. 7 is a schematic diagram of a communication device according to an embodiment of the disclosure. Referring to FIG. 7, the communication device 700 includes a substrate 701, a unit array, a plurality of scan lines S1_1 to S1_M and S2_1 to S2_M, a plurality of data lines D_1 to D_2N, a plurality of data drive circuits 730_1 to 730_P, and scanning circuits 741 and 742. In this embodiment, the substrate 701 has a first area 710 and a second area 720. The unit array is disposed in the first area 710 of the substrate 701 and has M rows and N columns of a plurality of units P(1,1) to P(N,M). The data lines D_1 to D_2N are disposed in the first area 710 of the substrate 701 and are coupled to units P(1,1) to P(N,M), and the number of data lines D_1 to D_2N is 2×N. In this embodiment, the scanning circuits 741 and 742 are disposed in the second area 720 of the substrate 701, the scanning circuits 741 and 742 are respectively coupled to a plurality of units in different rows through scan lines S1_1 to S1_M and S2_1 to S2_M, and the number of scan lines S1_1 to S1_M and S2_1 to S2_M is 2×M.

In this embodiment, the scan lines S1_1 to S1_M are disposed in the left half of the first area 710 of the substrate 701, and are coupled to units P(1,1) to P(N/2,M). The scan lines S2_1 to S2_M are disposed in the right half of the first area 710 of the substrate 701, and are coupled to units P((N/2)+1,1) to P(N,M). The data drive circuits 730_1 to 730_P may be coupled to units P(1,1) to P(N,M) through data lines D_1 to D_2N and provide a plurality of data signals to units P(1,1) to P(N,M). The scanning circuit 741 may be coupled to units P(1,1) to P(N/2,M) through scan lines S1_1 to S1_M and provide a plurality of scan signals to units P(1,1) to P(N/2,M), and the scanning circuit 742 may be coupled to units P((N/2)+1,1) to P(N,M) through scan lines S2_1 to S2_M and provide a plurality of scan signals to units P((N/2)+1,1) to P(N,M). In this regard, since the communication device 700 may scan units P(1,1) to P(N,M) through two scanning circuits 741 and 742, and the length of scan line S1_1 to S1_M and S2_1 to S2_M may be reduced to half. In this way, the signal attenuation problem of units farther from the scanning circuits 741 and 742 may be effectively improved.

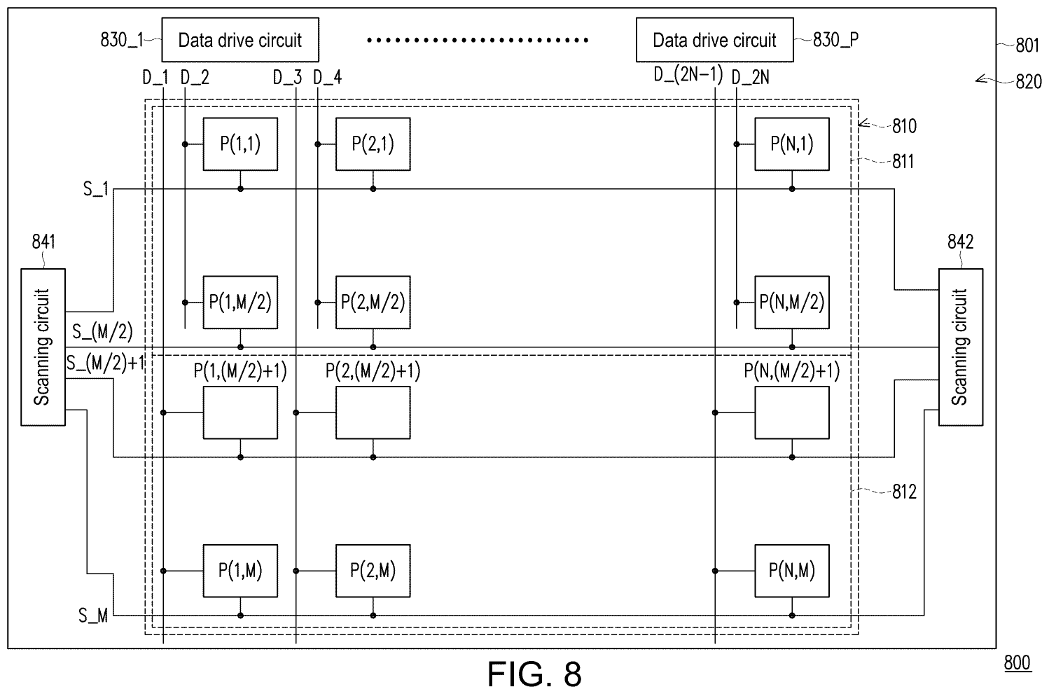

FIG. 8 is a schematic diagram of a communication device according to an embodiment of the disclosure. Referring to FIG. 8, the communication device 800 includes a substrate 701, a unit array, a plurality of scan lines S_1 to S_M, a plurality of data lines D_1 to D_2N, a plurality of data drive circuits 830_1 to 830_P, and scanning circuits 841 and 842. In this embodiment, the substrate 801 has a first area 810 and a second area 820. The unit array is disposed in the first area 810 of the substrate 801 and has M rows and N columns of a plurality of units P(1,1) to P(N,M). The data lines D_1 to D_2N are disposed in the first area 810 of the substrate 801 and are coupled to units P(1,1) to P(N,M), and the number of data lines D_1 to D_2N is 2×N. In this embodiment, the scanning circuits 841 and 842 are disposed in the second area 820 of the substrate 801, the scanning circuits 841 and 842 are coupled to two ends of scan lines S_1 to S_M, and the number of scan lines S_1 to S_M is M.

In this embodiment, the data drive circuits 830_1 to 830_P may be coupled to the units P(1,1) to P(N,M) through the data lines D_1 to D_2N, and provide a plurality of data signals to the units P(1,1) to P(N,M). The scanning circuit 841 and the scanning circuit 842 may be coupled to units P(1,1) to P(N/2,M) through scan lines S1_1 to S1_M, and synchronously provide a plurality of scan signals to units P(1,1) to P(N,M). In this regard, since the scanning circuit 841 and the scanning circuit 842 of this embodiment may synchronously provide corresponding scan signals to each of the scan lines S_1 to S_M. In this way, the signal attenuation problem of units farther from the scanning circuits 841 and 842 may be effectively improved.

In summary, the communication device and the driving method thereof of the disclosure may effectively shorten the duration of each frame period during the operation process of the communication device by synchronously driving a plurality of units in a plurality of sub areas of the unit array row by row. Moreover, the communication device and the driving method thereof of the disclosure may effectively improve the signal attenuation problem of units farther from the scanning circuits by simultaneously providing scan signals to the same scan line through two scanning circuits, or by scanning two scan lines coupled to a plurality of units in the same row through two scanning circuits.

Finally, it should be noted that the above embodiments are only used to illustrate the technical solutions of the disclosure and are not intended to limit it. Although the disclosure has been described in detail with reference to the above embodiments, persons of ordinary skill in the art should understand that they may still modify the technical solutions described in the above embodiments, or replace some or all of the technical features therein with equivalents, and that such modifications or replacements of corresponding technical solutions do not substantially deviate from the scope of the technical solutions of the embodiments of the disclosure.

What is claimed is:

1. A communication device, comprising:
a substrate;
a plurality of scan lines, disposed on the substrate and divided into R scan line groups, wherein R is a positive integer greater than 1; and
a plurality of data lines, disposed on the substrate,
wherein a number of the plurality of data lines is R×S, S is a positive integer, and R scan lines are simultaneously turned on.

2. The communication device according to claim 1, wherein the substrate has a first area and a second area, wherein the first area comprises R sub areas,
wherein R unit groups are respectively disposed in the R sub areas, and the plurality of data lines are respectively coupled to the R unit groups.

3. The communication device according to claim 2, further comprising:
a plurality of data drive circuits, respectively coupled to the plurality of data lines,
wherein a number of the plurality of data drive circuits is R.

4. The communication device according to claim 3, wherein the plurality of data drive circuits are coupled to each other in a cascade manner.

5. The communication device according to claim 3, wherein the plurality of data drive circuits synchronously drive a plurality of units in each of the R sub areas, and the plurality of units in each of the R sub areas are driven row by row.

6. The communication device according to claim 3, further comprising:
a scanning circuit, coupled to the plurality of scan lines,
wherein the scanning circuit performs row-by-row scanning on the plurality of units in the R sub areas synchronously by partitions.

7. The communication device according to claim 6, wherein waveforms of two data signals of every two adjacent rows of the plurality of data lines are partially overlapped.

8. The communication device according to claim 3, wherein the plurality of data drive circuits alternately drive a plurality of units in different columns of the R sub areas.

9. The communication device according to claim 8, wherein the plurality of data drive circuits are alternately coupled to a plurality of units in different columns.

10. The communication device according to claim 8, wherein the plurality of data drive circuits are respectively coupled to a plurality of units in different consecutive columns.

11. The communication device according to claim 5, wherein the plurality of units are a plurality of antenna transceivers.

12. The communication device according to claim 5, wherein each of the plurality of units comprises an operation circuit and a working element, the operation circuit is coupled to the working element, a corresponding data line, and a corresponding scan line.

13. The communication device according to claim 12, wherein the operation circuit drives the working element according to a data signal received.

14. The communication device according to claim 12, wherein the working element comprises a varactor, and the operation circuit charges the varactor in the working element according to a data signal received.

15. The communication device according to claim 2, further comprising:
two scanning circuits, disposed in the second area of the substrate, and the two scanning circuits are respectively coupled to a plurality of units in different rows through the plurality of scan lines.

16. The communication device according to claim 2, further comprising:
two scanning circuits, disposed in the second area of the substrate, and the two scanning circuits are coupled to two ends of the plurality of scan lines.

17. The communication device according to claim 1, wherein the substrate is a low-temperature polycrystalline silicon substrate.

18. The communication device according to claim 1, wherein the first area is an active area, and the second area is a peripheral area.

19. The communication device according to claim 1, wherein the communication device is an antenna device.

20. A driving method for a communication device, wherein the communication device comprises a substrate, a plurality of data lines, and a plurality of scan lines, the plurality of data lines and the plurality of scan lines are disposed on the substrate, the plurality of scan lines are divided into R data line groups, where R is a positive integer greater than 1, a number of the plurality of data lines is R×S, and S is a positive integer,
wherein the driving method comprises:
synchronously providing a plurality of data signals through the plurality of data lines to a plurality of units in each of a plurality of sub areas of the substrate; and
providing a plurality of scan signals through the plurality of scan lines to a plurality of units in different rows, wherein R scan lines are simultaneously turned on.
